(19) United States
(12) Patent Application Publication
(10) Pub. No.: US 2018/0143434 A1
(43) Pub. Date: May 24, 2018

(54) WEARABLE DISPLAY GLASSES WITH FORWARD PROTRACTIBLE AND RETRACTABLE CAMERA LENS

(71) Applicant: RED STREET VENTURES, LLC, Austin, TX (US)

(72) Inventor: Andrew Hamra, Austin, TX (US)

(73) Assignee: Red Street Ventures, LLC

(21) Appl. No.: 15/359,248

(22) Filed: Nov. 22, 2016

(51) Int. Cl. G02B 27/01; H04N 9/31; H04N 5/225; G09G 5/00

(52) U.S. Cl. CPC G02B 27/0172; H04N 9/3141; H04N 5/2252; G09G 5/003; G02B 2027/0154; G02B 2027/0178; G02B 2027/0138; G02B 2027/0141; G02B 2027/0147; G02B 27/0176

(57) ABSTRACT

Various embodiments relate to a pair of wearable glasses comprising a protractible and retractable mechanism mounted on or housed in a stabilizer of the pair of wearable glasses configured to extend away from the pair of wearable glasses, a camera mounted on an end of the protractible and retractable mechanism, a housing compartment mounted on or housed in the stabilizer, a projector mounted on the wearable glasses configured to display images captured by the camera and a remote device onto a display screen on the lens of the wearable glasses.

### FIELD OF THE INVENTION

This disclosure relates generally to a pair of glasses with a protracting and retracting camera, more specifically, the camera which extends forward from the pair of glasses to capture user's face for pictures and videos.

### BACKGROUND

Current technology only allows for people to communicate by way of using smartphones held in the palm of their hands and away from their body to take picture images and record videos, or use hand held “selfie sticks” to take these pictures and videos. However, by attaching a protractible extending camera to a pair of glasses, users will be able to keep their hands free and still capture their image or video in the position that a “selfie sticks” is configured to assist in capturing.

### SUMMARY OF EXEMPLARY EMBODIMENTS

A brief summary of various embodiments is presented below. Embodiments address the need to have a protractible extending camera attached to a pair of glasses which is able to capture image or video while keeping the user's hands free to use.

In order to overcome these and other shortcomings of the prior art and in light of the need for a protractible extending camera attached to a pair of glasses which is able to capture image or video while keeping the user's hands free to use, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a pair of wearable glasses including a protractible and retractable mechanism mounted on or housed in a stabilizer of the pair of wearable glasses configured to extend away from the pair of wearable glasses, a camera mounted on an end of the protractible and retractable mechanism, a housing compartment mounted on or housed in the stabilizer and a projector mounted on the wearable glasses configured to display images captured by the camera and a remote device onto a display screen on the lens of the wearable glasses.

In an embodiment of the present disclosure the housing further includes a battery, a processor and a motor configured to retract and protract the protractible and retractable mechanism.

In an embodiment of the present disclosure, the housing further includes a Bluetooth module configured to communicate with the remote device.

In an embodiment of the present disclosure, the housing further includes a USB port or other component configured to communicate with the remote device.

In an embodiment of the present disclosure, the housing further includes an earphone and an earphone arm for pivoting the earphone.

In an embodiment of the present disclosure, a microphone is mounted on the pair of wearable glasses.

In an embodiment of the present disclosure, the camera is configured to rotate and swivel.

In an embodiment of the present disclosure, the images captured by the camera are wirelessly transferred to the remote device.

In an embodiment of the present disclosure, the protractible and retractable mechanism includes a plurality of cylindrical tubes or other similarly shaped tubes which are configured to be extended away from the pair of wearable glasses to increase the distance between the pair of wearable glasses and the camera.

In an embodiment of the present disclosure, the projector is configured to receive the images from the camera and remote device and display the images on the display screen.

In an embodiment of the present disclosure, a prism is configured to improve clarity of the display screen.

In an embodiment of the present disclosure, the protractible and retractable mechanism are configured to be extended manually.

In an embodiment of the present disclosure, the stabilizer can be folded inward at a pivot point.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features of the invention are more fully disclosed in the following specification, reference being had to the accompanying drawings, in which:

FIG. 1 illustrates a front side angle view of the wearable glasses with camera lens retracted.

FIG. 2 illustrates a front side angle view of the wearable glasses with camera lens protracted.

FIG. 3 illustrates a side angle view of the wearable glasses showing protractible and retractable components in the retracted short position.

FIG. 4 illustrates a side angle view of the wearable glasses showing protractible and retractable components in the protracted extended view.

FIG. 5 illustrates a side angle view showing casing on the glasses that houses the projector, processor, Bluetooth unit and battery.

FIG. 6 illustrates a side angle view of the wearable glasses showing additional earphone, recharging input and microphone.

FIG. 7 illustrates a front view of the wearable glasses while the projector displays images from both camera and remote device. The wearable glasses display images on the lens which shows whatever is on the home screen of user's mobile device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE PREFERRED EMBODIMENTS

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable.

The component of the invention may include the pair of wearable glasses with two lenses connected by frames over the nose and two stabilizers that connect the frames to the area behind the ears on each side of the head.

A retractable and protractible mechanism is attached to one side of the pair of wearable glasses which can be extended manually or by use of motor.

The method of retraction and protraction is similar to that of a universal car antenna with several extensions housed within each other and which collapse within each other when retracted.

The retractable and protractible mechanism can be protracted and retracted by a remote control on the remote device (i.e. on/off, change application or viewable screen).

The retractable and protractible mechanism includes a camera at end of retractable and protractible mechanism which faces backwards (i.e. towards a user), but can be adjusted to face forward.

The pair of wearable glasses includes a processor within the housing which is attached to the stabilizer of the pair of wearable glasses. The housing also includes a battery, a projector, a Bluetooth module, and a communication device such as a USB port or a Wi-Fi module.

Furthermore, the pair of wearable glasses includes a display screen on the lens that is viewable by the user. The projection is a reflection of users' smartphone display, smartwatch display, tablet display, or mobile device display of any kind that is connected via the Bluetooth module. The projector may be attached to the stabilizers, either in front of or behind the frame.

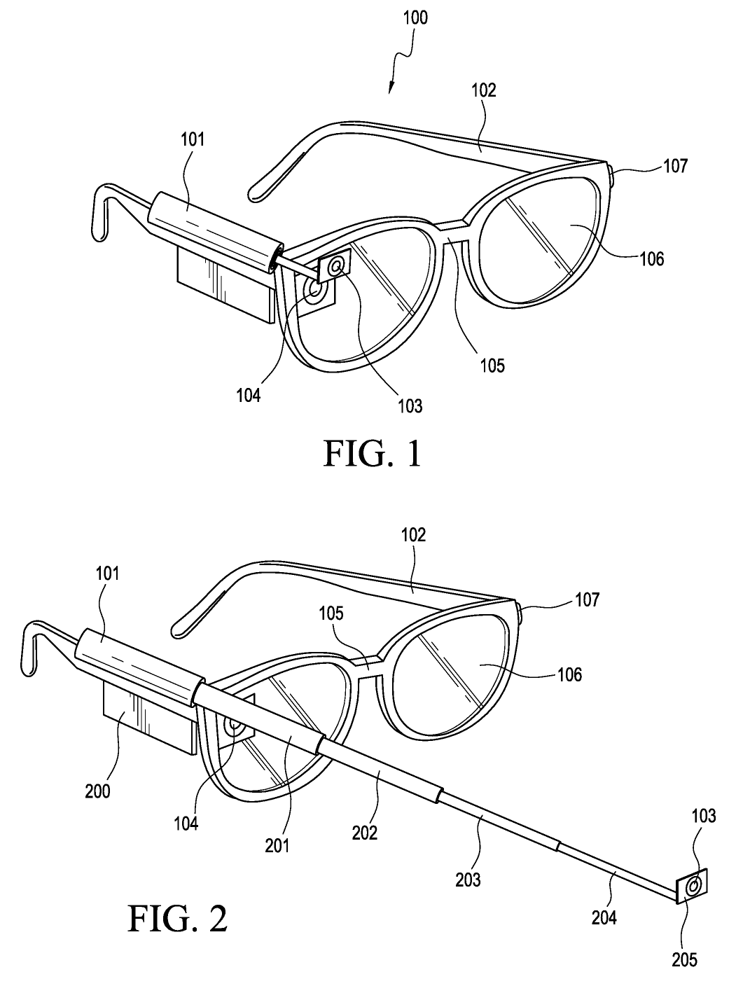

FIG. 1 illustrates a front side angle view of the wearable glasses with camera lens retracted. According to an aspect of the present embodiment, the pair of wearable glasses 100 includes a retractable and protractible mechanism 101 which is mounted to one side of a stabilizer 102. The camera 103 is connected to end of retractable and protractible mechanism 101. A display screen 104 can be attached to a stabilizer 102 or frame 105 of the pair of wearable glasses 100 and can function in front of or behind a lens 106 of the pair of wearable glasses 100. The stabilizer 102 can be folded for stowing away while not in use at a pivot point 107.

FIG. 2 illustrates a front side angle view of the wearable glasses with camera lens protracted. According to another aspect of the pair of wearable glasses 100, the retractable and protractible mechanism 101 with the camera 103 can be protracted and extended. The retractable and protractible mechanism 101 includes a plurality of cylindrical components (201, 202, 203, 204) which can be encased in a larger case on stabilizer 102. At the cylindrical component 204, the camera 103 may be mounted on a rotatable swivel 205.

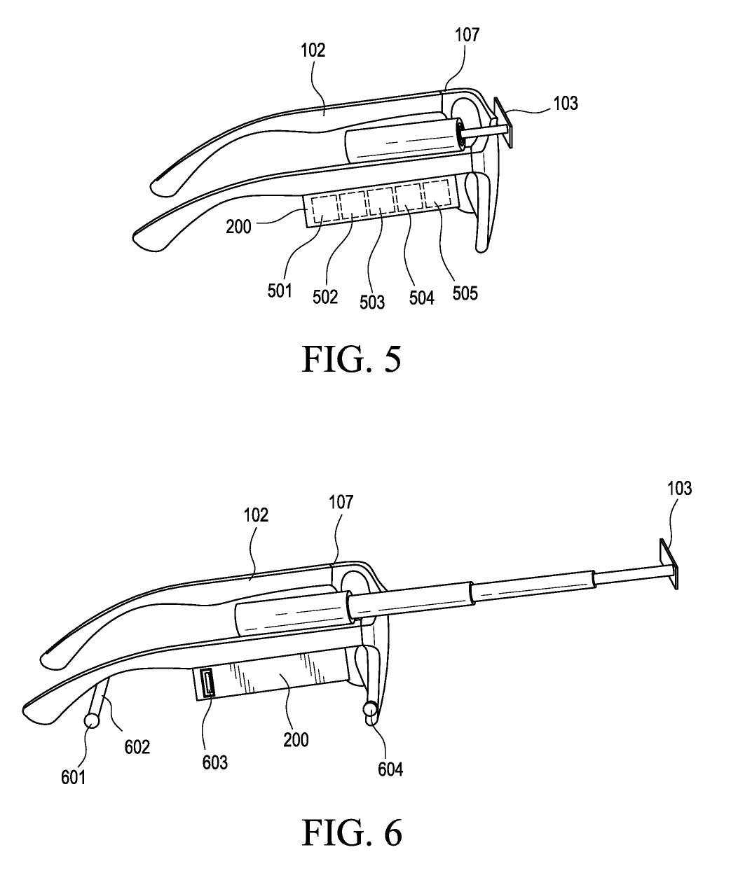

A housing 200 is mounted on the stabilizer 102 and includes a processor, Bluetooth module, a battery and a motor (which be discussed in more specificity in FIGS. 5 and 6).

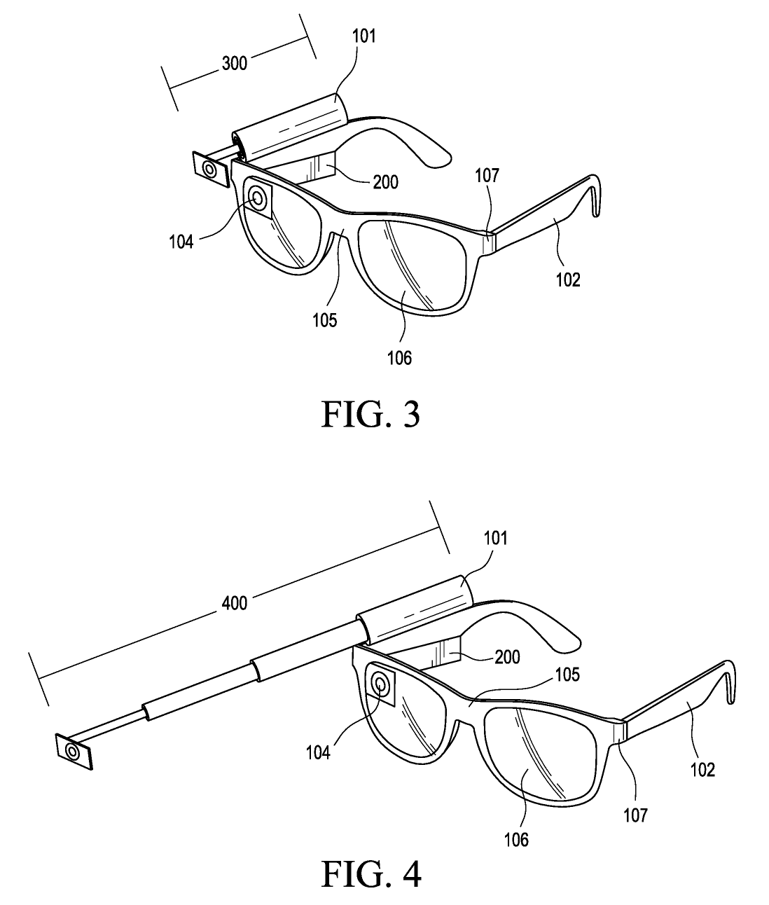

FIG. 3 illustrates a side angle view of the pair of wearable glasses 100 showing protractible and retractable component 101 in the retracted short position 300. The pair of wearable glasses 100 may be in a retracted position of approximately 2-3 inches which is the length of the housing 200. The camera 103 is connected to the smallest cylinder allowing for it to be pulled out manually or alternatively by a motor. It should be noted that the protractible and retractable component 101 may be in any other shape, including a square protractor component.

FIG. 4 illustrates a side angle view of the wearable glasses showing protractible and retractable components in the protracted extended view 400. The pair of wearable glasses 100 may be in a protracted position of approximately 4-16 inches and is variable as the user can determine appropriate length.

FIG. 5 illustrates a side angle view showing casing on the glasses that houses the projector, processor, Bluetooth unit and battery. The housing 200 includes a rechargeable battery 501. The housing 200 also includes a motor 502 which is used to protract and retract the retractable and protractible mechanism 101. The housing 200 also includes a Bluetooth module which allows images and other information to be shared with a remote device (i.e. smartphone). The housing further includes a processor 504 to handle images and information from the camera 103 and the remote device. Finally, the housing 200 includes a projector 505 which displays the images from the remote device onto the display screen 104 of the pair of wearable glasses 100.

FIG. 6 illustrates a side angle view of the wearable glasses showing additional earphone, recharging input and microphone. The housing 200 includes an earphone 601 that is connected to an earphone arm 602 which is adjustable or bendable component that attaches to the stabilizer 102 of the pair of wearable glasses 100. The housing 200 also includes a USB port 603 (or other communication port) or similar recharging interface for a battery 501. The housing 200 also includes a microphone 604 attached to the frame 105.

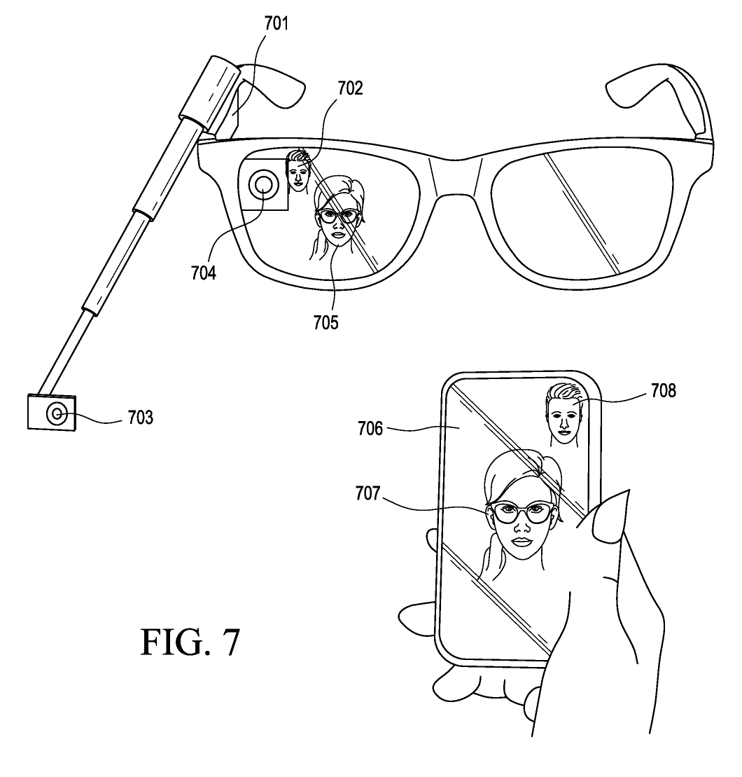

FIG. 7 illustrates a front view of the wearable glasses while the projector displays images from both camera and remote device. The pair of wearable glasses 100 displays images on the lens 704 which displays the content of the home screen of user's remote device. Images are a result of the image 702 being captured by the camera 703 on the pair of wearable glasses 100. The image 705 is received from a remote device 706 via the Bluetooth module 503. The image 707 is the same as 705 and the image 708 is the same as 702 allowing the user to communicate with a second user.

A prism can be used to improve the quality of the image.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A pair of wearable glasses comprising:
a protractible and retractable mechanism mounted on or housed in a stabilizer of the pair of wearable glasses configured to extend away from the pair of wearable glasses;
a camera mounted on an end of the protractible and retractable mechanism;
a housing compartment mounted on or housed in the stabilizer;
a projector mounted on the wearable glasses configured to display images captured by the camera and a remote device onto a display screen on the lens of the wearable glasses.

2. The pair of wearable glasses of claim 1, wherein the housing compartment further comprises a battery, a processor and a motor configured to retract and protract the protractible and retractable mechanism.

3. The pair of wearable glasses of claim 1, wherein the housing compartment further comprises a Bluetooth module configured to communicate with the remote device.

4. The pair of wearable glasses of claim 1, wherein the housing compartment further comprises a USB port or other component configured to communicate with the remote device.

5. The pair of wearable glasses of claim 1, wherein the housing compartment further comprises an earphone and an earphone arm for pivoting the earphone.

6. The pair of wearable glasses of claim 1, further comprising a microphone mounted on the pair of wearable glasses.

7. The pair of wearable glasses of claim 1, wherein the camera is configured to rotate and swivel.

8. The pair of wearable glasses of claim 1, wherein the images captured by the camera are wirelessly transferred to the remote device.

9. The pair of wearable glasses of claim 1, wherein the protractible and retractable mechanism includes a plurality of cylindrical, or other similarly shaped tubes which are configured to be extended away from the pair of wearable glasses to increase the distance between the pair of wearable glasses and the camera.

10. The pair of wearable glasses of claim 1, wherein the projector is configured to receive the images from the camera and remote device and display the images on the display screen.

11. The pair of wearable glasses of claim 1, further comprising a prism configured to improve clarity of the display screen.

12. The pair of wearable glasses of claim 1, wherein the protractible and retractable mechanism are configured to be extended manually.

13. The pair of wearable glasses of claim 1, wherein the stabilizer can be folded inward at a pivot point.
